(19) United States
(12) Patent Application Publication
(10) Pub. No.: US 2016/0069477 A1
(43) Pub. Date: Mar. 10, 2016

(54) Pipe Installation Device

(71) Applicant: Kenneth Tabor, Flower Mound, TX (US)

(72) Inventor: Kenneth Tabor, Flower Mound, TX (US)

(21) Appl. No.: 14/847,965

(22) Filed: Sep. 8, 2015

Related U.S. Application Data
(60) Provisional application No. 62/047,114, filed on Sep. 8, 2014.

(51) Int. Cl. F16L 1/024; F16L 3/16

(52) U.S. Cl. CPC F16L 1/0246; F16L 3/16

(57) ABSTRACT

An apparatus for the safe and efficient installation of large overhead pipes using a minimum number of workers. The present apparatus minimizes the hazards by providing a tool for supporting a large pipe throughout the installation process, which can easily be transported and lifted into place by a forklift or other similar means. A large and heavy pipe may be placed on pipe cradles extending from the base of the apparatus, which hold and support the pipe throughout installation. The pipe cradles may be positioned on supports which are stabilized by additional support arms to prevent the pipe cradle supports from leaning or collapsing. Forklift slots on the base of the apparatus can be used for receiving the prongs of a standard forklift, wherein the forklift may transport and lift the entire apparatus and pipe into place for a safe and efficient installation.

### CROSS-REFERENCE TO RELATED APPLICATIONS

This application claims the benefit of U.S. Provisional Application No. 62/047,114, filed on Sep. 8, 2014.

### TECHNICAL FIELD

The present invention relates to pipes and more particularly to the installation of pipes for overhead mechanical, plumbing, and fire sprinkler systems.

### DESCRIPTION OF PRIOR ART

Most commercial buildings use a variety of pipes for multiple systems operating throughout the buildings, such as mechanical, plumbing, and fire sprinkler systems. During construction of these commercial buildings, workers often lift pipes and sections of pipes overhead to properly create the various pipe systems. While some pipes and pipe sections may be small enough to manually lift overhead, many of the pipes are very large and/or heavy, making it difficult for the workers to lift and manipulate the pipes to properly place them into position.

Current methods for overhead installation of large pipes include manually lifting the large pipes using ladders, chains, and other manual, heavy-lifting equipment. Unfortunately, the use of multiple workers and manual, heavy-lifting equipment can be extremely hazardous due to the high potential for accidents caused by human error or equipment malfunction or inadequacy. Additionally, current methods require multiple workers as a single worker is generally incapable of lifting a large, heavy pipe individually. Utilizing multiple workers and manual, heavy-lifting equipment is a laborious process which slows the overall construction time and increases the costs of labor.

Accordingly, a need exists for an apparatus which allows workers to safely and efficiently install large overhead pipes. Such an apparatus would allow for a single worker to manipulate and install a large overhead pipe since the apparatus, rather than multiple workers, would lift a large overhead pipe into position during installation. Additionally, the apparatus would stabilize a large pipe during installation, preventing the pipe from falling and causing worker injury or expensive property damage.

### OBJECTS OF THE INVENTION

A primary object of the present invention is to lift and stabilize a large pipe during commercial pipe installation with a minimum amount of workers.

It is another object of the present invention to allow workers to safely and efficiently install large overhead pipes.

It is another object of the present invention to provide an apparatus to facilitate the installation of large pipes which cannot be handled by an individual.

It is another object of the present invention to enable a single worker to lift and install an oversized and/or heavy pipe regardless of pipe size, pipe weight, and availability of additional workers.

It is another object of the present invention to essentially eliminate dangers to worker safety due to loss of control of an oversized and/or heavy pipe during installation of said oversized and/or heavy pipe.

It is another object of the present invention to provide a more efficient and cost-effective method for installation of oversized and/or heavy pipes.

### SUMMARY OF THE INVENTION

The present invention is an apparatus used for the installation of large and heavy lengths of pipe for overhead pipe systems, including, but not limited to, mechanical, plumbing, and fire sprinkler systems. Rather than requiring multiple workers, ladders, and chains, the present apparatus allows a single worker to easily lift and manipulate a large and heavy pipe into the correct position for installation within a system. Additionally, the present apparatus minimizes potentially-hazardous working conditions such as large pipes being dropped due to worker error, chains slipping, or other heavy-lifting equipment failure.

In the present embodiment, the pipe installation apparatus is comprised of a base with an upper surface and a lower surface, pipe cradles, which hold and support a large pipe throughout the installation process, and pipe cradle support arms (i.e., elongated support means or pipe support mechanism). The pipe cradles are supported by a support arm extending vertically from the base of the pipe installation apparatus. Additional pipe cradle support arm stabilizers (i.e. connectors) are positioned around the pipe cradle support arms, to connect the pipe cradle support arms to each other and to the base to prevent leaning or collapsing of the pipe cradle support arms. In this embodiment, the base of the pipe installation apparatus features forklift slots for receiving the prongs of a standard forklift to allow for easy and secure lifting and moving of the entire pipe installation apparatus.

Workers may utilize the pipe installation apparatus by placing a large pipe on the pipe cradles, which are attached to pipe support arms attached to the base. The pipe may be lifted into place by using a fork lift to raise the pipe installation apparatus to an appropriate height and/or through the extension of a telescoping shaft on the pipe cradle support arms. The pipe may be secured in place within the pipe cradles using chains, cords, clamps, ropes, and straps, or other securing means to ensure that the pipe does not become dislodged from the pipe cradles during installation. The fork lift may then be used to lift the large pipe into place for installation by sliding the two prongs of the fork lift into precut slots in the pipe installation apparatus. The pipe installation apparatus may then be further secured to the fork lift, or other lifting machine, to prevent the pipe installation apparatus from slipping off the fork lift.

The present apparatus essentially negates the hazards of large overhead pipe installation typically present while utilizing current pipe installation methods and/or devices. With the present apparatus, a large pipe may be securely lifted overhead and placed in its proper position using a minimum number of workers, even a single worker, while also minimizing the risk of the pipe falling due to worker error, failure of a securing mechanism, or any other operational mishap. Accordingly, the present apparatus provides a more secure and efficient method for the safe installation of large overhead pipes.

### BRIEF DESCRIPTION OF THE DRAWINGS

FIG. 1 is an isometric view of a pipe installation apparatus embodying the principles of the present invention;

FIG. 2 is a front view of a pipe installation apparatus embodying the principles of the present invention;

FIG. 3 is a side view of a pipe installation apparatus embodying the principles of the present invention;

FIG. 4 is a close-up, isometric view of a pipe cradle and pipe cradle support system embodying the principles of the present invention;

FIG. 5 is an alternative, isometric view of a pipe installation apparatus embodying the principles of the present invention;

FIG. 6 is an alternative, isometric view of a pipe installation apparatus embodying the principles of the present invention.

### DETAILED DESCRIPTION OF DRAWINGS

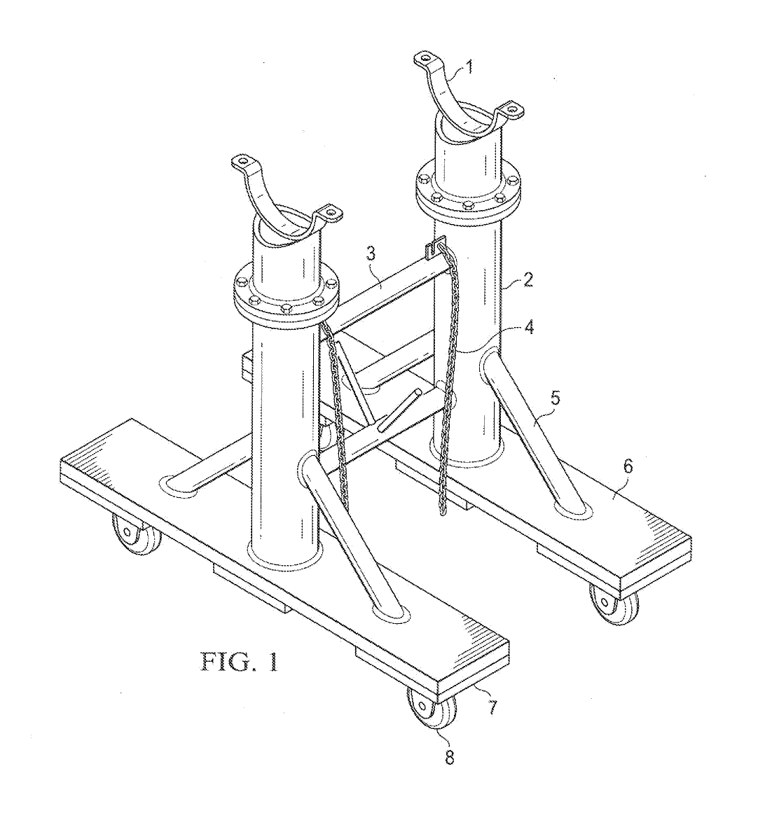

While the above description is of the preferred embodiment of the present invention, it should be appreciated that the invention may be modified, altered, or varied without deviating from the scope and fair meaning of the following description. Referring generally to FIGS. 1-6, the present disclosure is an apparatus for safely and efficiently installing large overhead pipes.

FIG. 1 depicts an isometric view of a pipe installation apparatus embodying the principles of the present invention. Due to the size and weight of many pipes used in commercial buildings, the preferred embodiment of the pipe installation apparatus may feature a pipe cradle 1 large enough to accommodate a variety of pipe sizes. Additionally, in the present embodiment, the two pipe cradles 1 and corresponding pipe cradle support arms 2 extending upward from the pipe installation apparatus base 6 are of equal height to ensure that a pipe is properly balanced on the pipe installation apparatus. In the present embodiment, the pipe cradle support arms 2 are stabilized by two sets of stabilizers. For vertical stabilization, each pipe cradle support arms 2 may be supported on either side by a vertical pipe cradle support arm stabilizer 5 that may be connected to both the pipe installation apparatus base 6 and the pipe cradle support 2 to be supported. For horizontal stabilization, the pipe cradle supports 2 may be connected by one or more horizontal pipe cradle support arm stabilizers 3 to ensure that the pipe cradle supports 2 neither bend towards or away from each other. In the preferred embodiment, the horizontal pipe cradle support arm stabilizers 3 are oriented perpendicularly with respect to the vertical pipe cradle support arm stabilizers 5 to ensure that the pipe cradle supports 2 are supported in all directions. Once a pipe is placed onto the pipe installation apparatus, the pipe and pipe installation apparatus may be secured into place using a securing mechanism 4, such as chains, cords, clamps, ropes, and straps, to secure the pipe to the pipe installation apparatus. In the present embodiment, the securing mechanism 4 is a chain. The pipe installation apparatus may feature forklift slots 7 for receiving the prongs of a standard forklift so the entire pipe installation apparatus may be transported and lifted into place using a standard forklift Alternatively, the location of the pipe installation apparatus may altered using movement facilitators such as wheels 8, (or even casters, friction slides, or ball bearings) attached to the bottom of the pipe installation apparatus base 6.

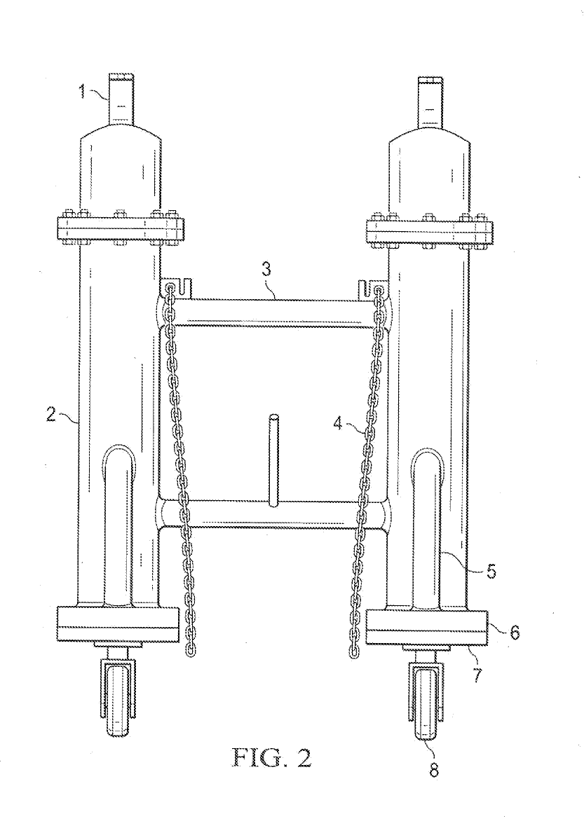

FIG. 2 depicts a front view of a pipe installation apparatus embodying the principles of the present invention. The forklift slots 7 featured in the present embodiment are more clearly shown in FIG. 2. As previously mentioned, in the present embodiment, a pipe may be placed on pipe cradles 1. which are supported by pipe cradle supports 2 extending vertically from the pipe installation apparatus base 6. The pipe cradle supports 2 may be further supported by horizontal pipe cradle support arm stabilizers 3, which connect the pipe cradle supports 2 to each other, and vertical pipe cradle support arm stabilizers 5, which may be connected to the pipe cradle supports 2 and the pipe cradle support base 6. A securing mechanism 4 may be used to secure a pipe to the pipe installation apparatus, and also to further secure the pipe installation apparatus to a forklift or some other means of transportation. The preferred embodiment of the pipe installation apparatus features forklift slots 7 for receiving the prongs of a standard forklift so that a single worker may move a large pipe into place for installation by using a forklift to transport and lift the entire pipe installation apparatus.

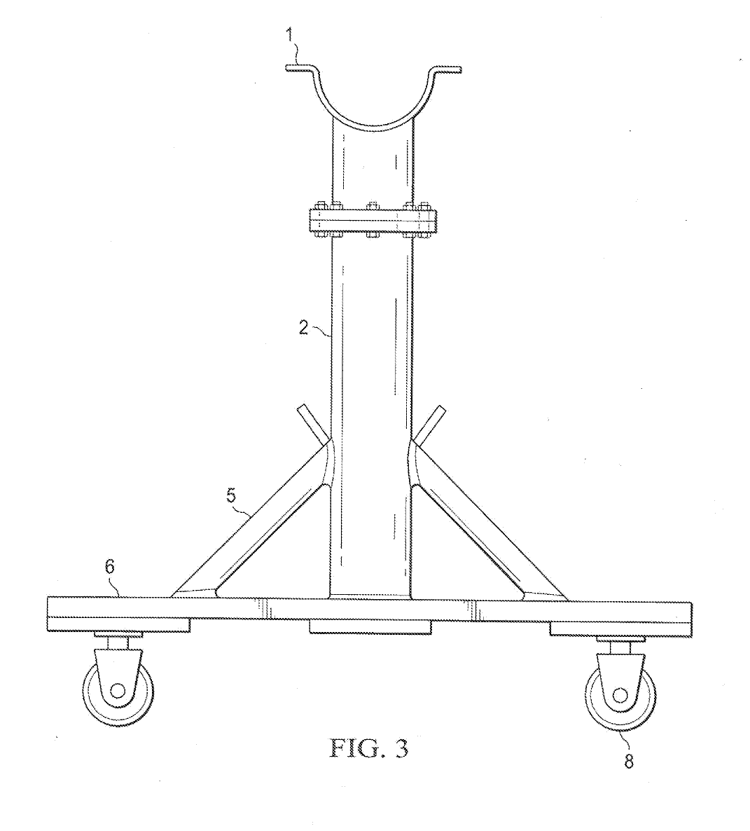

FIG. 3 depicts a side view of a pipe installation apparatus embodying the principles of the present invention. As previously mentioned, in the present embodiment, a pipe may be placed on pipe cradles which are supported by pipe cradle supports 2 extending vertically from the pipe installation apparatus base 6. As can be seen more clearly in FIG. 3, the pipe cradle supports may be stabilized by vertical pipe cradle support arm stabilizers 5 to ensure that the pipe cradle supports 2 remain vertical. Ensuring that the pipe cradle supports 2 remain vertical is important to prevent a pipe from falling and potentially causing severe injury or property damage.

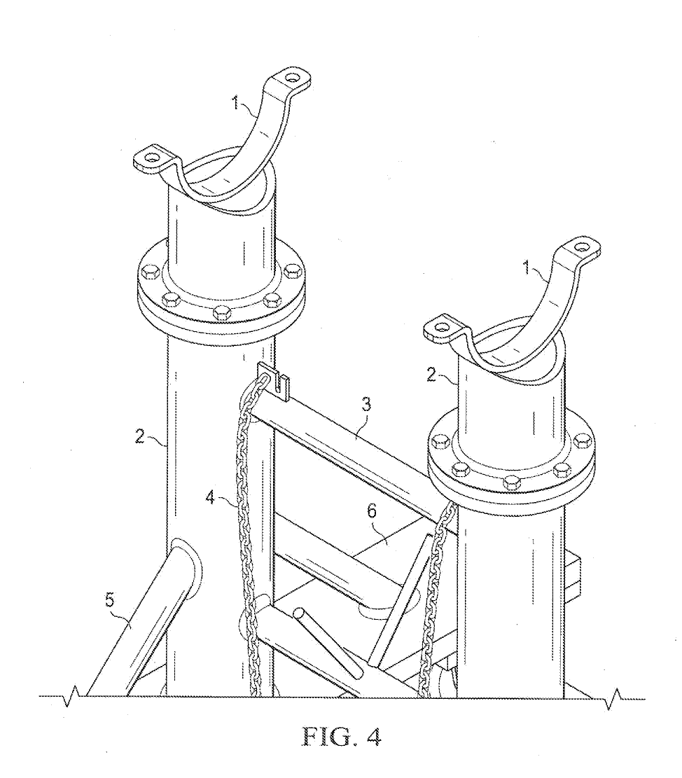

FIG. 4 depicts a close-up, isometric view of a pipe cradle and pipe cradle support system embodying the principles of the present invention. As previously mentioned, in the present embodiment, a pipe may be placed on pipe cradles 1 which are supported by pipe cradle supports 2 extending vertically from the pipe installation apparatus base. As can be seen more clearly in FIG. 4, the pipe cradles 1 may be open semi-circles to receive and hold a large pipe during the installation process. In the present embodiment, the pipe cradle supports 2 may be stabilized by vertical pipe cradle support arm stabilizers 5 to ensure that the pipe cradle supports 2 remain vertical. Additionally, in the present embodiment, the pipe cradle supports 2 may also be stabilized by horizontal pipe cradle support arm stabilizers 3 to ensure that the pipe cradle supports 2 neither bend towards or away from each other. A securing mechanism 4 may be used to secure a pipe to the pipe installation apparatus, and also to further secure the pipe installation apparatus to a forklift or some other means of transportation.

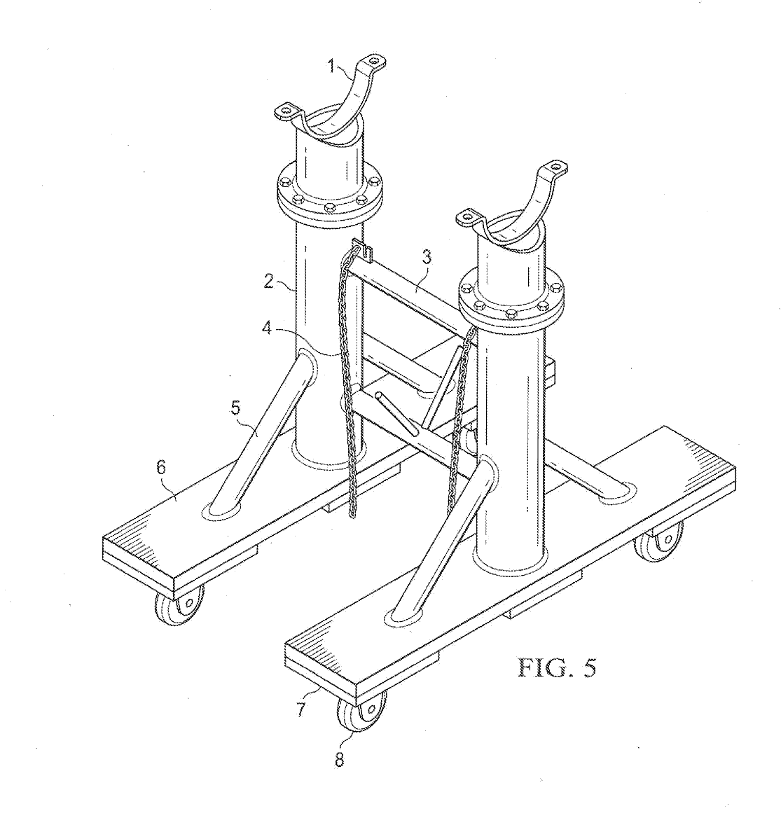

FIG. 5 depicts an alternative, isometric view of a pipe installation apparatus embodying the principles of the present invention. As previously mentioned, the preferred embodiment of the pipe installation apparatus may feature a pipe cradle 1 large enough to accommodate a variety of pipe sizes. Additionally, in the present embodiment, the two pipe cradles 1 and corresponding pipe cradle supports 2 extending upward from the pipe installation apparatus base 6 are of equal height to ensure that a pipe is properly balanced on the pipe installation apparatus. In the present embodiment, the pipe cradle supports 2 are stabilized by two sets of stabilizers. For vertical stabilization, each pipe cradle support 2 may be supported on either side by a vertical pipe cradle support arm stabilizer 5 that may be connected to both the pipe installation apparatus base 6 and the pipe cradle support 2 to be supported. For horizontal stabilization, the pipe cradle supports 2 may be connected by one or more horizontal pipe cradle support arm stabilizers 3 to ensure that the pipe cradle supports 2 neither bend towards or away from each other. In the preferred embodiment, the horizontal pipe cradle support arm stabilizers 3 are oriented perpendicularly with respect to the vertical pipe cradle support arm stabilizers 5 to ensure that the pipe cradle supports 2 are supported in all directions. Once a pipe is placed onto the pipe installation apparatus, the pipe and pipe installation apparatus may be secured into place using a securing mechanism 4, such as a chain or a cord, to secure the pipe to the pipe installation apparatus. In the present embodiment, the securing mechanism 4 is a chain. The pipe installation apparatus may feature forklift slots 7 for receiving the prongs of a standard forklift so the entire pipe installation apparatus may be transported and lifted into place using a standard forklift. Alternatively, the pipe installation apparatus may be moved using movement facilitators such as wheels 8 attached to the bottom of the pipe installation apparatus base 6.

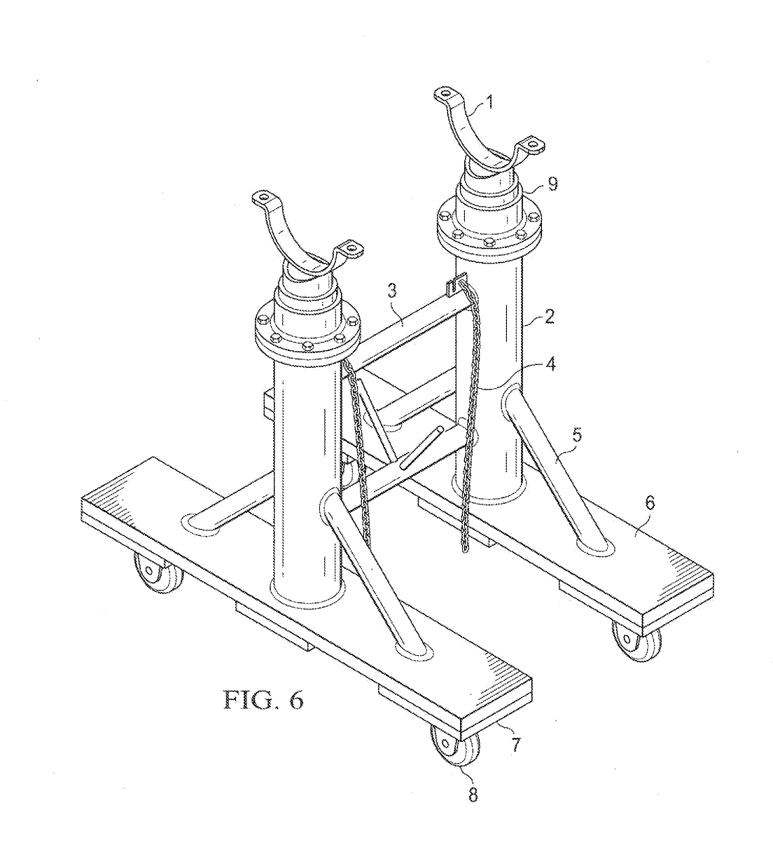

FIG. 6 depicts an alternative, isometric view of a pipe installation apparatus embodying the principles of the present invention. As previously mentioned, the preferred embodiment of the pipe installation apparatus may feature a pipe cradle 1 large enough to accommodate a variety of pipe sizes. Additionally, in the present embodiment, the two pipe cradles 1 and corresponding pipe cradle supports 2 extending upward from the pipe installation apparatus base 6 are of equal height to ensure that a pipe is properly balanced on the pipe installation apparatus, in the present embodiment, the pipe cradle supports 2 are stabilized by two sets of stabilizers. For vertical stabilization, each pipe cradle support 2 may be supported on either side by a vertical pipe cradle support arm stabilizer 5 that may be connected to both the pipe installation apparatus base 6 and the pipe cradle support 2 to be stabilized. For horizontal stabilization, the pipe cradle supports 2 may be connected by one or more horizontal pipe cradle support arm stabilizers 3 to ensure that the pipe cradle supports 2 neither bend towards or away from each other. In the preferred embodiment, the horizontal pipe cradle support arm stabilizers 3 are oriented perpendicularly with respect to the vertical pipe cradle support arm stabilizers 5 to ensure that the pipe cradle supports 2 are supported in all directions. Once a pipe is placed onto the pipe installation apparatus, the pipe and pipe installation apparatus may be secured into place using a securing mechanism 4, such as a chain or a cord, to secure the pipe to the pipe installation apparatus. Additionally, in the present embodiment, the pipe cradle support may feature a telescoping shaft 9 pipe cradle support to vary the height of pipe cradles 1—and, thus, a pipe—relative to the pipe installation apparatus base 6. Further, the pipe installation apparatus may feature forklift slots 7 for receiving the prongs of a standard forklift so the entire pipe installation apparatus may be transported and lifted into place using a standard forklift. Alternatively, the pipe installation apparatus may be moved using wheels 8 attached to the bottom of the pipe installation apparatus base 6.

What is claimed is:

1. A pipe installation apparatus comprising:
a base for holding a load;
elongated support means connected to said base for stabilizing said load;
means for securing said load to said pipe installation apparatus; and,
means for moving said pipe installation apparatus.

2. The pipe installation apparatus of claim 1, wherein said elongated support means are substantially perpendicular to said base.

3. The pipe installation apparatus of claim 2, wherein said elongated support means includes at least one adjustable pipe cradle support for holding said load.

4. The pipe installation apparatus of claim 3, wherein said pipe cradle support includes at least one pipe cradle attached to a top surface of said pipe cradle support.

5. The pipe installation apparatus of claim 4, wherein said adjustable pipe cradle support includes a telescoping shaft to adjust the height position of said load relative to said base.

6. The pipe installation apparatus of claim 4, wherein said elongated support means are permanently attached to said base.

7. The pipe installation apparatus of claim 5, wherein said means for securing said load to said pipe installation apparatus is selected from the group consisting of chains, cords, clamps, ropes, and straps.

8. The pipe installation apparatus of claim 6, wherein said means for moving said pipe installation apparatus is selected from the group consisting of wheels, casters, friction slides, and ball bearings.

9. The pine installation apparatus of claim 1, further comprising at least one optional connector to further stabilize said pipe installation apparatus.

10. The pipe installation apparatus of claim 9, further comprising at least one first connector secured to at least two elongated support means.

11. The pipe installation apparatus of claim 10, further comprising at least one second connector securing said elongated support means to said base.

12. A pipe installation apparatus for maneuvering oversized pipes comprising:
a base;
at least one pipe support mechanism; and,
at least one mobility mechanism.

13. The pipe installation apparatus of claim 12, wherein said base is further comprised of an upper base surface and a lower base surface.

14. The pipe installation apparatus of claim 13, wherein said pipe support mechanism is further comprised of:
a pipe cradle for holding a load;
a pipe support column, wherein said pipe support column is permanently attached to a posterior surface of said pipe cradle; and,
a securing mechanism for securing said load to said pipe cradle.

15. The pipe installation apparatus of claim 14, wherein said pipe cradle support is selected from the group consisting of stationary-shaft pipe cradle support and telescoping-shaft pipe cradle support.

16. The pipe installation apparatus of claim 14, wherein said pipe support mechanism is permanently connected to said upper base surface; wherein said mobility mechanism is connected to said lower base surface to facilitate movement of said pipe installation apparatus.

17. The pipe installation apparatus of claim 16, wherein said pipe support mechanism is substantially perpendicular to said base.

18. A method for maneuvering an unmanageable load for installation within a system comprising:
placing a load on a pipe cradle of a pipe installation apparatus;
adjusting the height of a telescoping-shaft pipe cradle support to accommodate installation of said load;
securing said load with securing means to said pipe cradle;
attaching said pipe installation apparatus to a transport device;
securing said load with securing means to said transport device; and
elevating said pipe installation apparatus to a position wherein said load may be installed.
